(19) United States
(12) Patent Application Publication
(10) Pub. No.: US 2017/0228803 A1
(43) Pub. Date: Aug. 10, 2017

(54) DYNAMIC MEDIA CONTENT VALUE BASED ON PREDICTED MONETIZATION VALUE

(71) Applicant: Morgan Francois Stephan Dollard, Belmont, CA (US)

(72) Inventor: Morgan Francois Stephan Dollard, Belmont, CA (US)

(73) Assignee: GOOGLE INC., Mountain View, CA (US)

(21) Appl. No.: 13/462,385

(22) Filed: May 2, 2012

(51) Int. Cl. G06F 21/00; G06Q 30/02; G06Q 30/00; G06Q 40/00

(52) U.S. Cl. CPC G06Q 30/0601

(57) ABSTRACT

Systems and methods for media content licensing are disclosed. A reception component can receive a media file and an analysis component analyzes the media file in connection with a set of quality metrics. The analysis component can also determine characteristics of the media file including potential monetization of a new media file that integrates the media with other media content. A matching component can match the media file to a set of other media content for potential integration with the media file. In an aspect, the matching is based on the potential monetization of a new media file generated by integration of the media file with the subset of the other media content. A licensing component further presents the media file to an owner of a subset of the other media content to consider granting a license to use the subset of the other media content with the media file.

### TECHNICAL FIELD

This disclosure relates to media content licensing, particularly to facilitating collaboration between media content owners based on a predicted monetization of the collaboration.

### BACKGROUND

A significant issue with publishing homegrown media content relates to managing unauthorized use of copyrighted content (e.g., music, audio, images . . . ) merged with the homegrown media content (e.g., video). For example, some developers of video may dub unauthorized copyrighted music to their video in order to enhance the video. Third party publishers of content, advertisers, and etc. spend considerable resources attempting to police unauthorized use of copyrighted content. Moreover, owners of copyrighted works (e.g., famous music artists) also spend considerable resources policing the Internet to detect and cease unauthorized use of their respective copyrighted works. In addition to costs associated with such enforcement efforts, there also is potential opportunity costs in not partnering up with certain homegrown developers in connection with monetizing their works.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with dynamic media content licensing.

In accordance with a non-limiting embodiment, in an aspect, a system is provided comprising a reception component that receives a media file and an analysis component that analyzes the media file in connection with a set of quality metrics. The system also include a matching component that matches the media file to a set of other media content for potential integration with the media file. In turn, a licensing component presents the media file to an owner of a subset of the other media content to consider granting a license to integrate the subset of the other media content with the media file. In an aspect, the matching component performs the matching based in part on potential monetization of a new media file generated by integrating the media file with the subset of other media content.

In another non-limiting embodiment, a method is provided comprising receiving a media file and analyzing the media file in connection with a set of quality metrics. Then the media file is matched to a set of other media content for potential integration with the media file. The method further comprises presenting the media file to an owner of a subset of the other media content to consider granting a license to integrate the subset of the other media content with the media file. In an aspect, the matching comprises matching the media file to a set of other media content based in part on potential monetization of a new media file generated by integrating the media file with the subset of other media content.

In yet another embodiment, a system is provided comprising a reception component that receives a media file and an analysis component that analyzes the media file in connection with a set of quality metrics and determines one or more characteristics of the media file. The system further comprises an auctioning component that presents the media file to publishers of other media content having one or more similar characteristics of the one or more characteristics of the media file. In turn, a licensing component receives a bid for a license to use the media file and grants the license to use the media file to a highest bidder.

Further provided is a system comprising means for receiving a media file, means for analyzing the media file in connection with a set of quality metrics, means for matching the media file to a set of other media content for potential integration with the media file, and means for presenting the media file to an owner of a subset of the other media content to consider granting a license to integrate the subset of the other media content with the media file.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting media collaboration system that facilitates dynamic media content licensing.

FIG. 2 illustrates an example of another non-limiting media collaboration system that facilitates dynamic media content licensing.

FIG. 3 illustrates an example of another non-limiting media collaboration system that facilitates dynamic media content licensing.

FIG. 4 illustrates an example of another non-limiting media collaboration system that facilitates dynamic media content licensing.

FIG. 5 illustrates an example of another non-limiting media collaboration system that facilitates dynamic media content licensing.

FIG. 6 illustrates an example of a non-limiting media collaboration system that facilitates dynamic media content auctioning and licensing.

FIG. 7 illustrates an example of a non-limiting media collaboration system that facilitates dynamic media content auctioning and licensing.

FIG. 8 illustrates an example methodology for dynamic media content licensing.

FIG. 9 illustrates an example methodology for dynamic media content licensing and auctioning.

FIG. 10 is a block diagram representing an exemplary non-limiting networked environment in which various embodiments can be implemented.

FIG. 11 is a block diagram representing an exemplary non-limiting computing system or operating environment in which various embodiments may be implemented.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

It is to be appreciated that in accordance with one or more embodiments or implementations described in this disclosure, users can opt-out of providing personal information, demographic information, location information, proprietary information, sensitive information, or the like in connection with data gathering aspects. Moreover, one or more embodiments or implementations described herein can provide for anonymizing collected, received, or transmitted data.

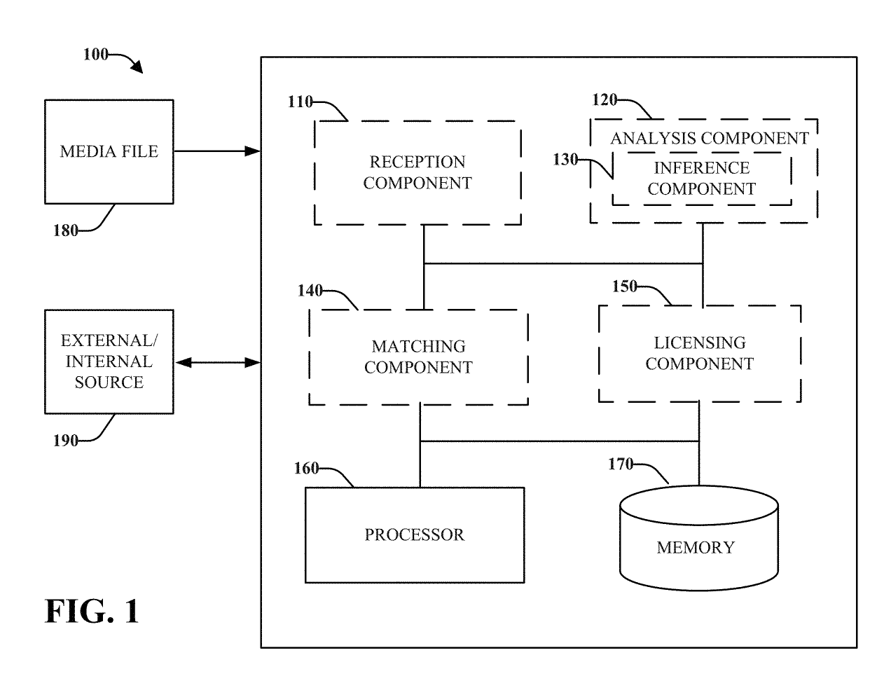

Referring now to the drawings, with reference initially to FIG. 1, a media collaboration system 100 that facilitates dynamic media content licensing is presented. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 170 for storing computer executable components and instructions. A processor 160 can facilitate operation of the computer executable components and instructions by the system 100.

System 100 receives and processes media files 180. In particular, system 100 facilitates collaboration between media content owners, providers, and promoters. In an embodiment, system 100 employs a reception component 110, an analysis component 120 that can include an inference component 130, a matching component 140 and a licensing component. In an aspect, reception component 110 receives a media file 180 and analysis component 120 analyzes the media file in connection with a set of quality metrics. Then, matching component 140 matches the media file to a set of other media content for potential integration with the media file. The other media content can include content located at an external or internal source 190. Licensing component 150 further presents the media file to an owner of a subset of the other media content to consider granting a license to integrate the subset of the other media content with the media file.

As used herein, media content includes digital media content including but not limited to, video data, audio data, image data, or animation data. For example, media content can include movies, television, streaming television, video games, pictures, or music tracks. In an aspect, media content is stored in media files. For example, a media file 180 can include a video recording file, an audio recording file, an image file, an image series file, or an animation file. Media content can include media data associated with one or more data sources 190 that can be received and/or transmitted by a client device or by media collaboration system such as system 100 (and additional systems described in this disclosure). A data source 190 can include one or more data stores storing media content and affiliated with a content provider that interacts with the media collaboration system 100. In another aspect, a data source 190 can include any data store that stores media content remote or external from media collaboration system. Still in yet another aspect, a data source 190 can include any data store storing media content internally at media collaboration system.

A client device can include any suitable computing device associated with a user and configured to interact with or receive media content. For example, a client device can include a desktop computer, a laptop computer, a smart-phone, a tablet personal computer (PC), or a PDA. As used in this disclosure, the terms “content consumer” or “user” refer to a person, entity, system, or combination thereof that employs media collaboration system 100 (or additional systems described in this disclosure). In an aspect, a client device or media collaboration system 100 (or additional systems described in this disclosure) can be configured to access, transmit and/or receive media content via a network such as for example the Internet, intranet, or cellular service.

According to an embodiment, reception component 110 receives a media file 180 which is then processed by system 100. The media file 180 is processed in order to determine other media content which may benefit from collaboration with the media file 180. In an aspect, the media file 180 received by reception component 110 can include homegrown media content. As used herein, the term homegrown media content generally refers to original media content generated by amateur users or individuals unaffiliated with corporate media production. For example, homegrown media content can include a home video of taken by an individual on his or her cellular phone. Further, the other media content that may benefit from a collaboration with a received media file 180 can include mainstream media content. As used herein, the term mainstream media content generally refers to original media content produced by corporate media production. For example, mainstream media content can include media content produced by a media corporation or a music production company for the purpose of generating revenue.

The terms homegrown media content and mainstream media content are used herein merely to differentiate from different types of media content that may be combined my media collaboration system 100 (and additional systems described herein) in accordance with various aspects of the subject disclosure. It should be appreciated that throughout the subject disclosure, reference to media files 180 received by reception component 110 as homegrown media content and reference to the other media files to which received media files 180 are matched with for collaboration as mainstream media content, is merely employed for exemplary purposes. Any suitable type of media content can be received by media reception component 110 and matched for potential licensing with any other type of media content. For example, media content including the media content received and accessed by media collaboration system 100 can include registered and unregistered copyrighted material.

In an embodiment, users can provide reception component 110 with a media file 180 for the purpose of achieving collaboration with other media content. For example, a user may submit a personal home video to media collaboration system 100 with hopes of receiving a license to employ other media content in a new media work combining the user's media file and the other material. In another aspect, reception component 110 can scan media sources 190 for media files to determine potential pairings between media files 190 and other media content. For example, reception component 110 can perform a continuous scanning process to find media files or a periodic scanning process. Reception component 110 can further randomly select to receive media files in response to scanning or employ an intelligence agent (not shown) to facilitate selecting media files to receive in response to a scan.

Analysis component 120 analyzes received media files 180 in order to facilitate determining potential collaborations between the received media files and other media content. Analysis component 120 determines or infers (e.g., via inference component 130), various characteristics of a received media file 180 that can later be employed by matching component 140 to match the media file 180 with other media content. The analysis component 120 also analyzes other media content in a same or similar manner as a received media file to identify or determine characteristics of the other media content. In addition, analysis component 120 can determine and/or infer (e.g., via inference component 130), potential monetization of a new media file generated by integrating the received media file with other media content. The matching component 140 can further employ the potential monetization of the new media file generated by integrating the received media file with the other media content to facilitate matching the media file 180 with the other media content.

In an aspect, analysis component 120 vets received media files 180 against one or more metrics to determine various technical characteristics of the media file 180 including but not limited to: type, format, resolution, encoding, quality, and fidelity. In an aspect, the technical characteristics of a media file 180 can be grouped as quality metrics and can include measures for determining media resolution, format, encoding, fidelity, and etc., including but not limited to measurements of signal-to-noise ratio (SNR), peak signal-to-noise ratio (PSNR), perceptual evaluation of video quality (PEVQ), structural similarity (SSIM), and czenakowski distance (CZD).

In one embodiment, the analysis component 120 can determine whether a received media file meets a pre-determined quality threshold required to undergo matching the received media file 180 with other potential media content for integration with the media file. In another embodiment, the analysis component 120 can associate a received media file with various quality metrics and/or technical metrics. For example, the analysis component 120 can associate a received media file 180 with a general quality score and/or results for determinations in various contributing quality categories, including format, resolution, encoding, and fidelity. The associated quality score and/or contributing technical metrics can later be employed by the matching component 140 as consideration factors when selecting matches of other media content for potential integration with the media file 180. Further, the associated quality score and/or metrics for a received media file 180 can be taken into consideration when determining licensing agreements between the received media file and other matched content.

Similarly, the analysis component 120 can also determine technical characteristics and requirements of other media content. For example, the analysis component 120 can determine the quality of other media content as well as features including type, format, resolution, encoding, quality, and fidelity. Later, the analysis component 120 and/or the matching component can further determine or infer correlations and similarities between technical characteristics of other media content and a received media file 180.

In another aspect, analysis component 120 can determine substantive characteristics of a media file 180 and other media content, including but not limited to author, artist, or producer of a media file, context of creation of a media file, and other content based characteristics of a media file 180. For example, the analysis component 120 can extract information about a media file and other media content from metadata associated with the media file 180 and/or the other media content. In another aspect, the analysis component 120 can employ a search engine (not shown) to find substantive information about a media file and/or other media content available at one or more data sources 190. The analysis component 120 can also determine features of a media file 180 and other media content including length, object movement, rhythm, and mood. Further, the analysis component 120 can analyze content of a media file 180 and other media content to determine or infer what the media file is about. For example, the analysis component 120 can determine or infer a description of a video.

In an embodiment, the analysis component 120 can employ audio and video analysis software to perform various analysis of video and audio content to determine substantive characteristics of a media file 180 and other media content. For example, the analysis component 120 can determine rhythm, beat, pitch, intonation, dialect, language, instrumentation, etc. in an audio track that includes vocal sound and a plurality of types of musical instrument sounds. As a result, the analysis component 120 can estimate information including but not limited to, rhythms, moods, notes, instruments, words, voices, styles, genres, tempos, patterns, and etc. associated with an audio track. In another example, the analysis component 120 can determine movement of objects in the media content, identity of objects, changes in dimensions of objects (such as changes in dimensions associated with close ups and fade outs), colors present in different frames of a media file, words or noises spoken or written in a media item and/or inflection associated with the words or noises spoken in a media item.

In another embodiment, the analysis component 120 can analyze and determine or infer (e.g., via inference component) social value associated with a media file and or other media content. As used herein, the term social value relates to the popularity of a media file with respect to one or more demographic audiences. In an aspect, the analysis component 120 can determine or infer current and prospective social value of a media file and/or other media content based on user interest in media content. For example, the analysis component 120 may determine that a particular media file comprising footage of a popular football game is popular with men between the ages of 12 and 60. In an embodiment, the analysis component 120 can determine user interest in media content associated with a media file or other media content based at least in part on content consumer traffic associated with the media content. In an aspect, analysis component 120 can determine user interest in media content based on user interaction of media content, including but is not limited to, viewing a section of a media content, controlling playing of a section of media content, bookmarking a section of media content, referencing a section of media content, communicating a section of media content, posting or storing a section of media content, tagging or bookmarking a section of media content.

In yet another aspect, the analysis component can employ extrinsic information to determine social value of a media file 180 and/or other media content. For example, extrinsic information can include but is not limited to, world wide web (web) postings associated with sections of media content, clippings of sections of media content, web links associated with the sections of the media content, user queries associated with the media content, or information regarding user interest in media content associated with social networking websites. According to this aspect, extrinsic information can be employed by the analysis component 120 to determine or infer content consumer interest media content. For example, multiple views of a particular of media content accompanied by postings of links to the particular section of the media content and multiple search queries for the particular media content can be employed as a measure of content consumer interest in the particular section of the media content.

The analysis component 120 can further examine patterns in media content that receives relatively high user interest to identify characteristics of media content that correlate to user interest. For example, the analysis component 120 may determine that video clips featuring celebrities are more popular than video clips featuring unknown individuals, or that video clips with attractive people are generally popular compared to similar video clips featuring unattractive people. The analysis component can further attribute a higher social value to media content that includes one or more identified popular characteristics.

In addition to various characteristics and features of media files 180 and other media content, the analysis component 120 can determine and/or infer potential monetization of a new media file generated by integrating a received media file 180 with other media content. The analysis component 120 can employ a variety of techniques to determine and or infer potential monetization of a new media file generated by integrating a received media file 180 with other media content. In an aspect, the potential monetization of a new media file can be a function of the social value of a new media file attributed to the joining of the content, the audiences reached, and attraction and integration of the new media content by advertisers. For example, mainstream media content may reach an otherwise unresponsive demographic audience through the integration into a popular homegrown video.

In another embodiment, potential monetization of a new media file can be a function of the quality of the new media file based in part on the individual quality of the media file 180 and the other media content in which it is integrated. In yet another embodiment, the analysis component 120 can examine and determine potential monetization of a new media file as a function of trends in media content, including trends between previous media content joinings and the monetization value resulting there from. Further, the analysis component 120 can examine and determine potential monetization of a new media file as a function of target audiences of advertisers, techniques of advertisers, and popular products and services of advertisers which would likely be enhanced through association with the new media file.

In an embodiment, the analysis component 120 can employ an inference component 130 to facilitate making inferences or determinations in connection with determining characteristics of media files 180, determining characteristics of other media content, and potential monetization of a new media file generated by integrating a received media file 180 with other media content. In order to provide for or aid in the numerous inferences described in this disclosure, inference component 120 can examine the entirety or a subset of data to which it is granted access and can provide for reasoning about characteristics of media files 180, other media content, and potential monetization of a new media file generated by integrating a received media file 180 with other media content. Inference component 130 can be granted access to any information associated with collaboration system 100, including information logged and/or monitored by analysis component 120 and stored in memory 170, as well as accessible extrinsic information. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events or data.

Such inference can result in construction of new events or actions from a set of observed events or stored event data, whether or not the events are correlated in close temporal proximity, and whether the events and data come from one or several event and data sources. Various classification (explicitly or implicitly trained) schemes or systems (e.g., support vector machines, neural networks, expert systems, Bayesian belief networks, fuzzy logic, data fusion engines, etc.) can be employed in connection with performing automatic or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is utilized to develop models of priority.

Referring back to FIG. 1, in an embodiment matching component 140 matches a received media file 180 to a set of other media content for potential integration with the media file 180. In an aspect, the set of other media content can include any media content accessible by media collaboration system 100 at one or more internal or external data sources 190. In another aspect, the set of other media content can include media content affiliated with media collaboration system 100, such as media content to which media collaboration system has previously received permission to employ. Still in yet another aspect, the set of other media content can include a subset of all other media content to which media collaboration system 100 is granted access to employ that has been restricted by one or more initial narrowing parameters applied by the matching component 140 in response to an initial analysis of a received media file by analysis component 120. For example, analysis component may determine initial technical characteristics of a media file such as quality or format, and the matching component 140 may identify a subset of other media that can be matched to the media file which employ a same or similar quality and/or format.

In an embodiment, matching component 140 matches a received media file to a set of other media content based on one or more characteristics of the media file and the set of other media content and/or potential monetization of a new media file generated by integrating the media file with the subset of other media content. For example, technical characteristics of a media file and other media content as determined by the analysis component 120 can include but are not limited to type, format, resolution, encoding, quality, and fidelity. Substantive characteristics of a media file and other media content can include but are not limited to author, artist, producer, cast, context of creation, subject matter or content, rhythm, mood, beat, tone style, genre, and etc. In an aspect, a characteristic of a video or audio file can include a description of what the video or audio content is about. In addition, a characteristic of a media file and other media content can include its social value and factors contributing to social value.

In an aspect, the matching component 140 can identify one or more similarities and/or correlations between a received media file 180 and other media content based on their respective characteristics. The matching component 140 then matches the received media file 180 to the set of other media content for potential integration with the media file based on the one or more similarities and/or correlations to identify a subset of the other media content which the matching component determines as “good” matches for integration with the media file 180. The matching component 140 can employ any technique to determine a “good” match. In an aspect, the matching component 140 can select the top ten matches having the greatest percentage of similarities and/or having the highest degree of correlation. In another aspect, the matching component 140 can be configured to select matches having a having a percentage of similarity and/or degree of correlation that surpasses a predetermined threshold value. In an aspect, licensing component 150 can then present the subset of good matches to an owner of the subset of the other media content to consider granting a license to integrate the subset of the other media content with the media file.

In an embodiment, the matching component 140 can identify correlations and similarities between a media file other media content based on data trends in media indicating correlations between media content characteristics and correlations between media content characteristics and monetization value. In an aspect, the trends can relate to positive trends regarding media content characteristics and monetization value as well as negative trends regarding media content characteristics and monetization value. For example, positive trends can be pre-defined and relate to generally accepted uses of media content that also results in an increase in monetization value. According to this example, a positive trend could be associated with media content use that includes non-discriminative use, non-offensive use, non-vulgar use, and etc. while a negative trend could be associated with discriminative, offensive, or vulgar use of media content. The matching component 140 can further be configured to match media content based on positive trends while avoiding matching based on negative trends.

According to this aspect, any of the matching component 140, analysis component 120, and/or inference component 120 can identify correlations between media characteristics through analysis of existing media. For example, the analysis component 120 may determine that general history shows that certain type of video often is employed with a certain type of song. For example, the analysis component 120 may determine that a media file is a snowboarding video and find other snowboarding videos having audio tracks associated therewith. The matching component 140 can then identify the audio tracks associated with the other snowboarding videos as possible audio tracks for integration with the snowboarding media file.

In an embodiment, the matching component 140 can perform matching of a media file to a subset of other media content based in part on a determined or inferred description of the media file. For example, the matching component 140 may match homegrown video having the description of “funny video of a woman falling of her chair” with other media content having a similar description or with a lighthearted audio track with a “boom” noise that can be matched to the timing of the woman's fall in the video. In another embodiment, the matching component 140 can perform matching of media files with other media content based on a potential monetization of a new media file generated by integrating the media file with a subset of other media content. For example, the analysis component 120 can determine or infer (e.g., via inference component) the potential monetization of paired media content. In turn, the matching component 140 can be configured to select subset of media content as “good” matches with a media file when the potential monetization of the integrated media content is above a predetermined threshold.

Still in yet another aspect, the matching component 140 may employ a variety of factors including similarities and/or correlations in characteristics, potential monetization, and social value associated with a media file and/or other media content, in order to determine good matches. For example, the matching component can associate matches with a weighted score based on the various factors employed and find matches having a score surpassing a predetermined value. According to this example, the matching component 140 may determined that a media file has a strong correlation with a subset of other media content, and also determine that the other media content has a high social value. Further, the matching component 140 may determine that the combined media content has a high potential monetization. As a result, the matching component 140 may determine that the media file and the subset of the other media content is a good match having a match score of for example, 8 out of 10.

Licensing component 150 is configured to present received media files 180 to an owner of media content the matching component identifies as good or qualifying potential matches. In turn, the owner of the subset of the other media content that is matched to a media file 180 can consider granting a license to the owner of the media file 180 to integrate the subset of the other media content with the media file. For example, the licensing component 150 may send an owner of a subset of the other media content and electronic message indicating one or more media file 180 that have been matched with his or her subset of other media content. The electronic message can further include a description of the basis for the match, such as information about the media file, scores associated with the match, and/or a potential monetization value associated with the integration of the media file with the owner's media content.

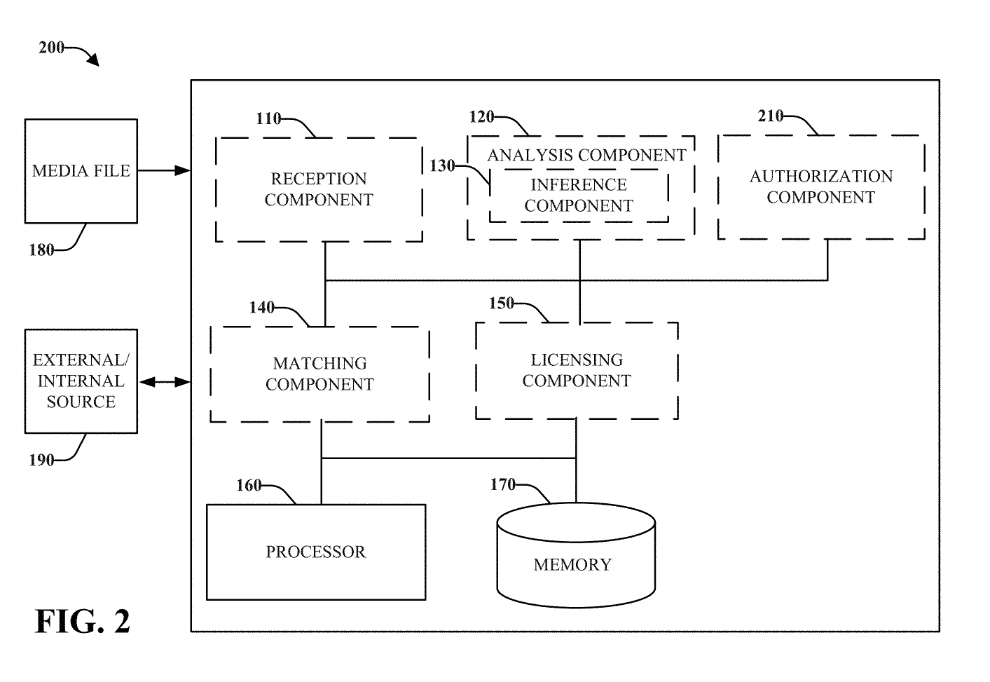

With reference to FIG. 2, presented is another exemplary non-limiting embodiment of a media collaboration system 200 that facilitates dynamic media content licensing in accordance with the subject disclosure. System 200 can include authorization component 210 that authorizes granting a license to integrate the subset of the other media content with the media file 180 when the potential monetization of a new media file generated by integrating the media file with the subset of the other media content is above a pre-determined threshold. In an aspect, in response to authorization by authorization component 210, an owner of the media file 180 can automatically be granted a license to integrate the subset of the other media content with his or her media file and upon granting, begin legal integration and use.

In an embodiment, the authorization component 210 automatically authorizes the granting of licenses based on media content owner authorization information provided by the content owner. According to this embodiment, content owners, or assignee's thereof, can pre-authorize licensing agreement regarding their media content by providing system 200 with authorization information. In an aspect, content owners can provide system 200 with authorization information regarding licensing agreements in general which can be stored by the system in memory 170. In another aspect, authorization component 210 may access licensing authorization information for content owners stored at an external data store (not shown). In an aspect, users can opt-out of providing personal information in connection with providing authorization information.

In an aspect, content owner authorization information can specify requirements for authorizing a licensing agreement with respect to his or her media content. For example, a media content owner may provide authorization for authorization component 210 to automatically authorize a licensing agreement to allow integration of his or her media content with that of another when the potential monetization of a new media file generated by integrating the media file with the subset of the other media content is above a pre-determined threshold.

In another aspect, a content owner may specify other parameters for which automatic authorization of licensing agreements regarding his or media content may be granted. For example, authorization information may set limits for quality levels, subject matter of content, or authors and producers of creation. According to this example, a content owner may automatically authorize a licensing agreement for when potential monetization is above ten thousand dollars, when the quality of owner of the media content to which the license is granted is above a specified grade, when the subject matter of the other media content does not include lewd content, and when the author or producer is not John Smith. In an aspect, any media content owner, including owners of media files received by system 200 and owners of media content accessed by system 200, may provide authorization information for the automatic granting of licensing agreements by authorization component.

Additional parameters for which automatic authorization of a licensing agreement may be granted can account for the intended use of media content. According to this aspect, a media content owner may only grant automatic authorization of his or media content when the licensee agrees to use the media content a required by the licensor. For example, a media content owner may forbid usage of his or her media content in a political satire, in an offensive or crude manner, or in a politically correct manner. In an aspect, in order to receive automatic authorization for a license to user certain media content, the authorization component can require the licensee to select a dialog box indicating agreement to the usage parameters defined by the content owner of the licensor.

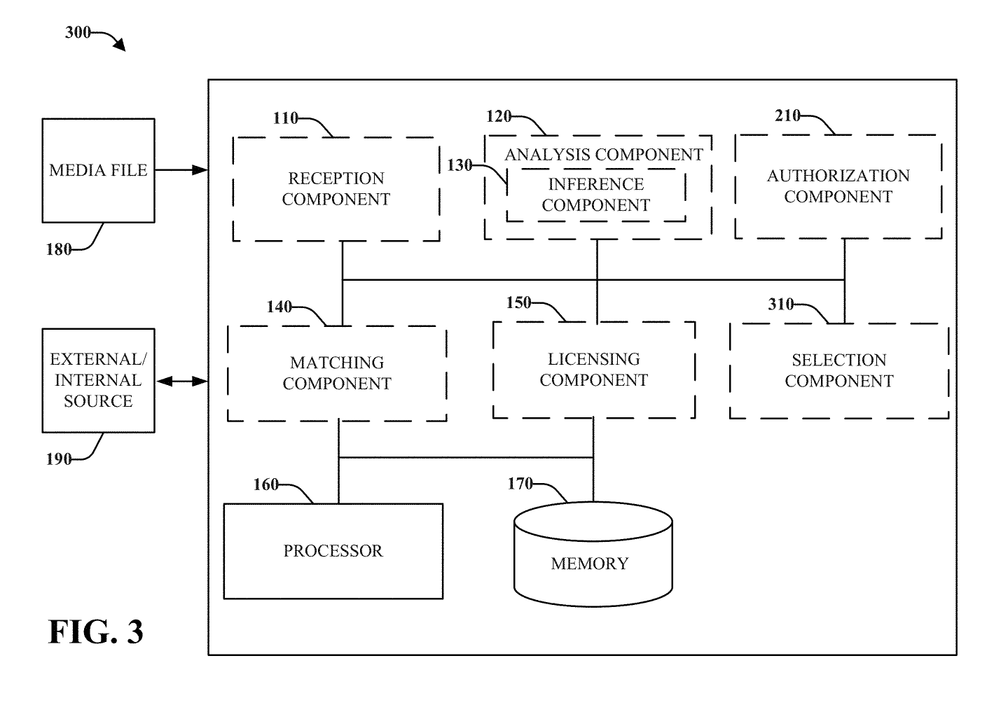

With reference to FIG. 3, presented is another exemplary non-limiting embodiment of a media collaboration system 300 that facilitates dynamic media content licensing in accordance with the subject disclosure. System 300 can include selection component 310 that receives user preferences of owners of received media files 180 that they may have regarding other media content that they may desire to integrate with their media files 180. In an embodiment, the matching component 140 can perform matching based in part on the user preferences. In an aspect, users can opt-out of providing personal information in connection with providing user preference information.

In an aspect, a user of system 300 may provide preferences regarding the other media content to match with his or her media content. The user can include the owner or affiliate of a received media file. In an aspect, a user may submit a media file 180 to system 300 for processing, including matching the media file 180 with other media content. The owner can further provide selection component 310 with various user preferences regarding the other media content to match with his or her media file. For example, the owner may indicate characteristic requirements of the other media content, such as technical characteristics and substantive characteristics. In another aspect, the user may provide general preferences regarding a user's likes, dislikes, and associations. For example, a user may indicate genres of music he likes, actors he likes, political parties he likes, his demographic affiliations, his age, his educational status, his marital status, and etc. In another example, the user may provide preferences regarding matches the he or she does not favor, including matches which facilitate offensive use, lewd use, inappropriate use, use with media content including a political agenda, or use with media content including profanity, and etc. In turn, the matching component can match a media file associated with the user to a set of other media content for potential integration with the media file based on his or her preferences.

In an embodiment, a user may provide preference information to selection component in the form a user profile. A user may provide system 300 with a profile comprising preference information which can be associated with the user each time the user submits a media file 180 or each time system 300 receives a media file associated with the user. The user profile can further be stored in memory 170. In another aspect, selection component can employ extrinsic information associated with a user to determine user preferences. For example, selection component may extract user preferences from a profile of the user associated with a social networking website.

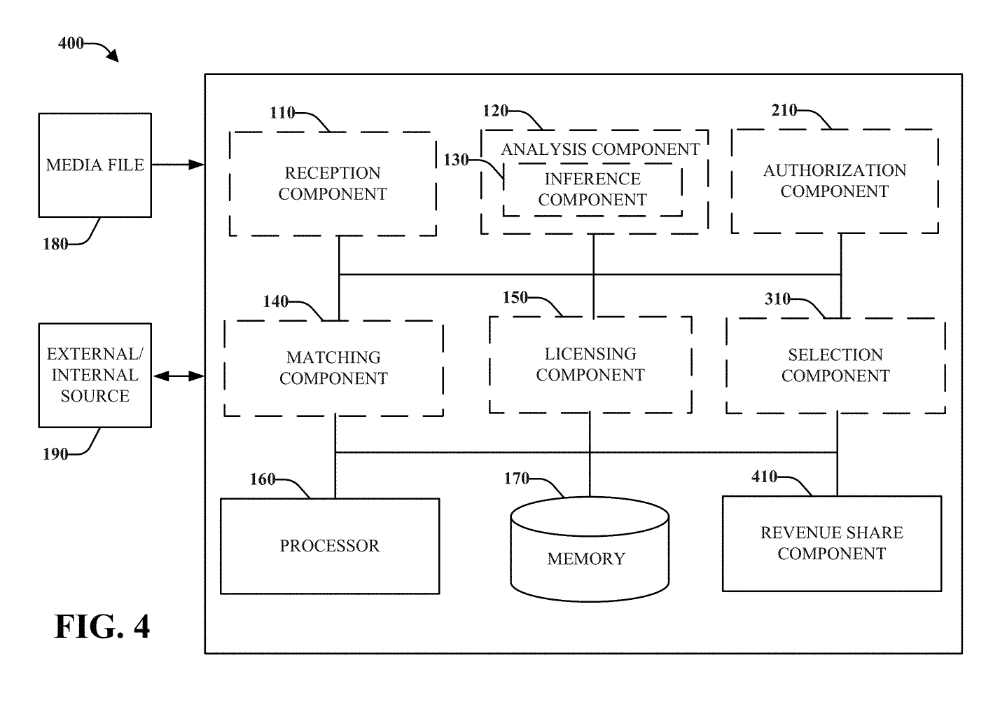

Referring now to FIG. 4, presented is another exemplary non-limiting embodiment of a media collaboration system 400 that facilitates dynamic media content licensing in accordance with the subject disclosure. System 400 can include revenue share component 410 that shares revenue with owners of content associated with a new media file generated by integrating the media file with the subset of other media content. The revenue share component 410 can provide for auditing and distributing revenue to respective parties associated with the new media file in accordance with a granted license.

In an embodiment, the licensing component 150 presents the media file to an owner of a subset of the other media content to consider granting a license to integrate the subset of the other media content with the media file. In another embodiment, the authorization component can automatically authorize the granting of the license. Regardless of the manner in which a license is obtained, the license can provide an agreement governing the monetary distribution of revenue earned from a new work or media file generated by integrating a received media file 180 with other media content. For example, a licensing agreement may include terms that provide the licensor (i.e. owner of the other media content) with 75 percent of the revenue generated from the new work and the licensee (i.e. the owner of the received media file 180) with 25 percent of the revenue generated from the new work.

The revenue share component 410 is configured to monitor the usage of the new work and any revenue generated in connection with the usage of the new work. The revenue share component can further track money owed to respective parties and provide the respective parties indication of the money owed thereto. In an aspect, the revenue share component can also control the distribution of revenue generated by the new work. For example, the revenue share component 410 can collect money generated through usage of the new work in a joint account associated with the new work. The revenue share component can further distribute to the money to individual accounts of the respective contributing parties from the joint account based on the parameters regarding monetary distribution in the licensing agreement. It should be appreciated that an aspect, users can opt-out of providing personal information in connection with monitoring and revenue sharing aspect. Further, one or more security measures can be employed by revenue share component keeps confidential financial information provided by users secure.

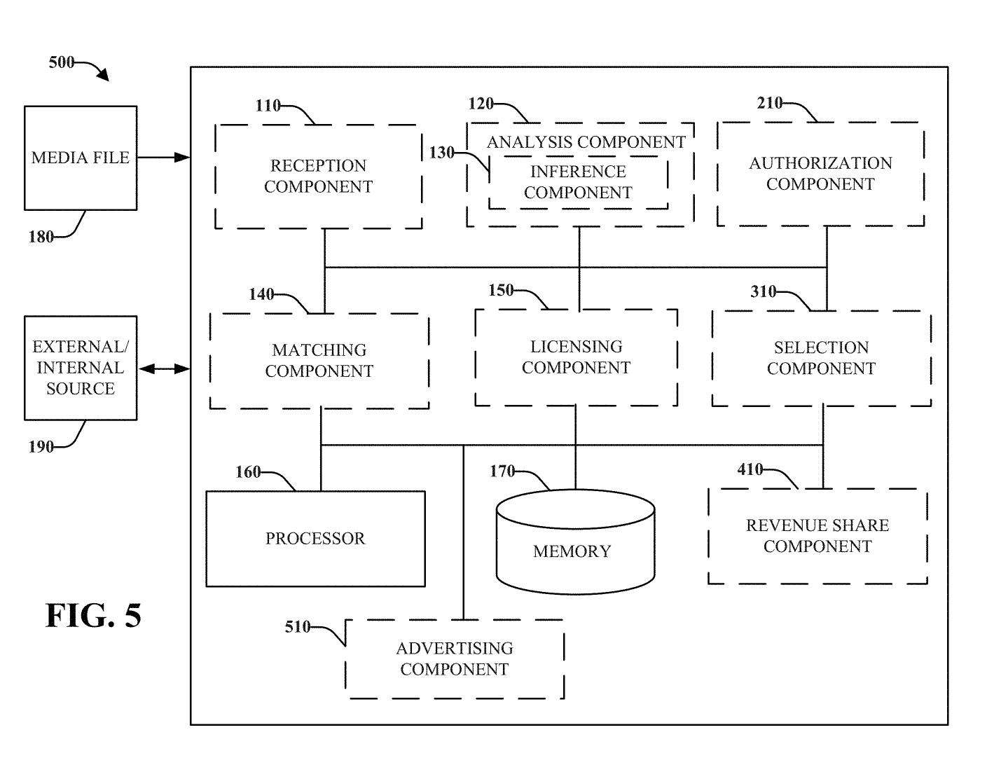

Referring now to FIG. 5, presented is another exemplary non-limiting embodiment of a media collaboration system 500 that facilitates dynamic media content licensing in accordance with the subject disclosure. System 500 can include advertising component 510 that presents a new media file generated by integrating a received media file 180 with other media content to potential advertisers in connection with purchasing advertisement space associated with the new media file. In an aspect, advertising component 510 can employ analysis component 120 and associated inference component 130 to facilitate determining potential advertisers who may be interested in purchasing advertisement space associated with the new media file.

System 500, via analysis component 120 and/or inference component 130 can identify and rank media content of user interest and popular segments of media that likely to have impact on particular content consumers, relevant to user interest, or likely to capture content consumer attention. In addition, the analysis component 120 and/or inference component 130 can determine or infer respectively, the types of media content that draw audiences who may be interested in a product or service associated with an advertiser or advertisement. Further, the analysis component 120 and/or inference component 130 can determine or infer respectively, the aims and interests of various advertisers.

The advertising component 510 can then determine good matches between respective advertisements, new media files, target audience, geography, user demographics, purchasing history, etc. in order to facilitate optimizing advertising in connection with provisioning of new media file content generated by integrating a received media file with other media content. In turn, the advertising component 510 can present the new media file to potential advertisers in connection with purchasing advertisement space associated with the new media file. Moreover, the advertising component 510 can facilitate pricing of advertising impressions. For example, a content provider can charge a premium for display of an advertisement around a new media file having a high social value or high potential monetization value. In an embodiment, the matching component 140 can perform matching of media content based in part on historical information and/or market trending data to identify strong matches between media content such as video, licensed content, and advertisers. The analysis component 120 and/or inference component 130 can determine or infer, respectively, historical information and market trending data by tracking and analyzing behavior of advertisers and through analysis of extrinsic information indicating current market trends.

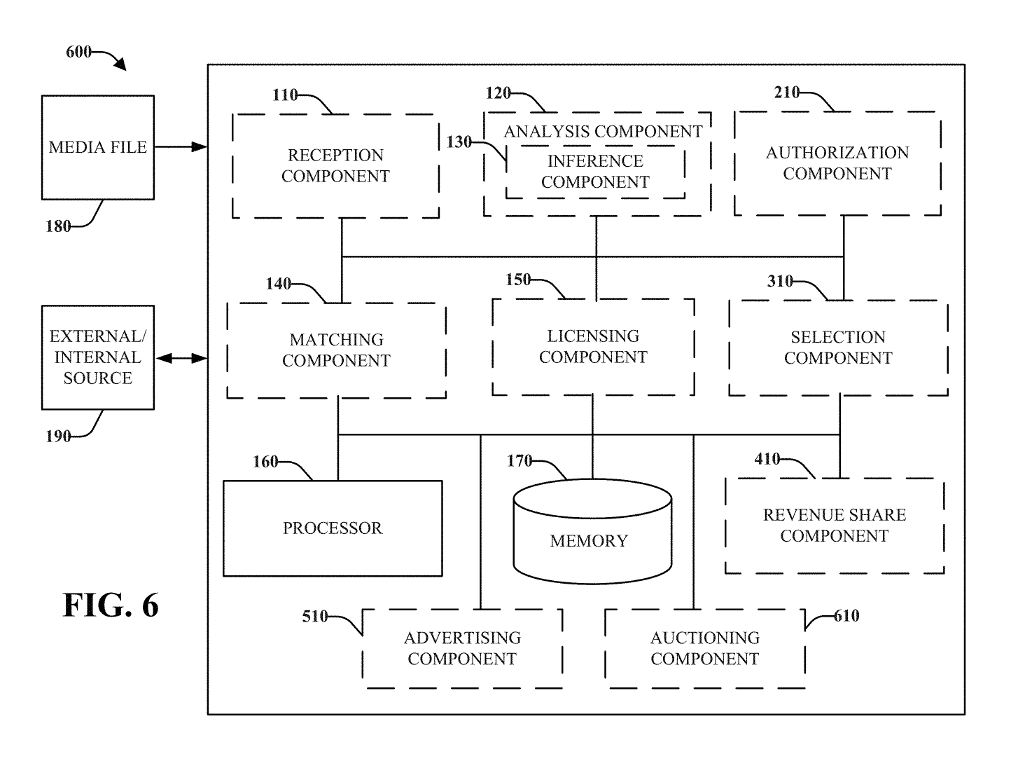

With reference to FIG. 6, presented is an exemplary non-limiting embodiment of a media collaboration system 600 that facilitates dynamic media content auctioning and licensing in accordance with the subject disclosure. System 600 facilitates media collaboration by allowing owners of media content to auction their media content for licensed use by others. For example, an owner of a homegrown media file may auction his or her work to publishers of other media content related to the homegrown media file. The publishers may for instance aggregate related media content to generate a complete body of media (e. g. an aggregation of homegrown video clips of sports highlights for a news report). In an aspect, system 600 can enable dynamic generation of greatest hits for a music genre, clips of recent sports highlights, or popular items for news feeds. System 600 can include an auctioning component 610 that presents a received media file 180 to publishers of other media content in an auctioning format. In turn, licensing component 150 can receive bids for a license to use the media file 180. In an aspect, the licensing component 150 can grant the license to use the media file to a highest bidder.

In an embodiment, the analysis component 120 analyzes a received media file 180 and determines one or more characteristics of the media file 180. For example, the analysis component 120 may determine technical characteristics, substantive characteristics, social value, and or potential monetization of the media file when associated with or integrated with other media content associated with various publishers. The auctioning component 610 can then present the media file to the publishers of other media content so that they may bid on receiving a license to use the media file. In an aspect, the auctioning component 610 can present the media file 180 to a publisher of media content having one or more similar characteristics of the one or more characteristics of the content of the media file 180. For example, the auctioning component 180 may present sports video clips to sports highlight providers. In another aspect, the auctioning component can associate the one or more characteristics of the media file 180 with the media file in a searchable form. Providers of media content can then conduct a search for media content based on a characteristic and find respective media files being auctioned by auctioning component 610 that have the characteristic.

Auctioning component 610 can provide a bidding format that enables licensing component 150 to receive bids for a license to use a media file 180. As used herein, the term publisher of media content can include any user or entity that uses media content. In an aspect, a publisher of media content can include a user or entity that intends to publish media content, including a media file 180 for which it is granted a license to use.

Licensing component 150 can employ a variety of methods of granting licenses for usage of auctioned media content. In an aspect, the licensing component 150 can receive bids for a license to use a media file 180 and grant the license to use the media file to a highest bidder after a predetermined duration of time. In another aspect, the licensing component 150 can receive bids and grant a license to any bidder willing to pay a predetermined amount of money for the license. Still in yet another aspect, the licensing component 150 may provide various licensing agreement parameters, and provide the license to the bidder willing to accept the license which most favors the media file owner based on values provided by the media file owner. For example, a media file owner 180 may indicate that he values receiving a high percentage of shared revenue from usage of his media file and further short term time limits on usage. As a result, a bidder willing to accept a licensing contract that provides the media file owner with the highest percentage of shared revenue and the shortest duration of time will win the license to use the media file.

In an aspect, revenue share component 410 can be configured to share revenue associated with usage of an auctioned media file by the highest bidder or bid winner with owners of the media file and the highest bidder or bid winner in response to granting the license. For example, such media content may be auctioned off by the content owner for a percentage of revenue share based on advertising revenue generated by the end piece of his or her media content when associated with other media content of a bid winner.

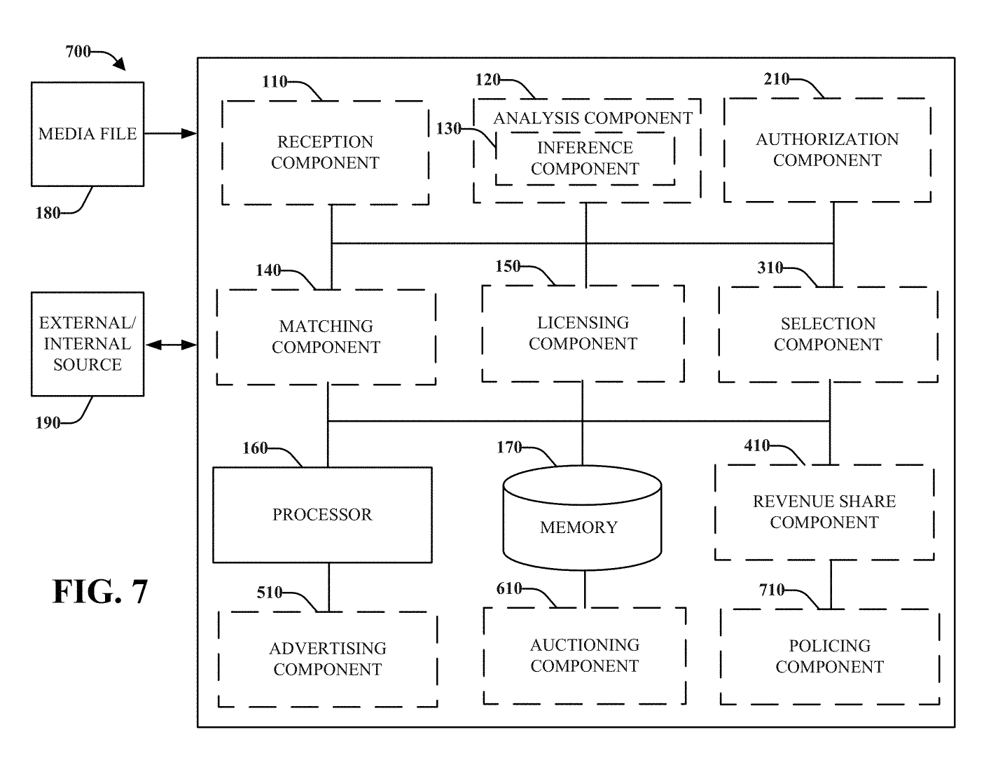

Referring now to FIG. 7, presented is another exemplary non-limiting embodiment of a media collaboration system 700 that facilitates dynamic media content licensing and auctioning in accordance with the subject disclosure. System 700 can include policing component 710 to facilitate policing proper usage of licensed media content. In an aspect, a user can automatically and/or upon manual review, authorize a license based in part on agreement of the licensing to abide by usage requirements. For example, a licensor may require that his media content not integrated with other media content in the form of a political satire or for lewd purposes. In another aspect, a user may provide user preferences to facilitate matching of his or her media content with other media content. The user preferences can also provide likes and dislikes regarding matching of his or her media content. For example, the user may indicate that she does not like her media content matched with media content comprising cartoon characters with brown hair and blue skin.

Policing component 710 can monitor usage of licensed media content to determine if the licensed media content is being used in accordance with usage parameters associated with the licensing agreement. Similarly, policing component 710 can monitor the activity of matching component 140 to determine whether the matching component is performing matching in accordance with user preferences. Policing component can employ analysis component 120 and/or inference component 130 to facilitate determining abidance to user licensing agreement parameters and/or user preferences.

In an aspect, the policing component 710 can issue a notification to a media content owner and/or the licensee, if the policing component 710 determines an improper use or an improper matching of licensed media content. In yet another aspect, the policing component 710 can employ revenue share component 410 to apply a penalty system that deducts revenue from an improper user of media content. For example, in a licensing agreement where the licensor and the licensee are entitled to receive equal shares of revenue generated by a new work of their joined content, if the licensee uses the licensed media content in an improper way, the policing component 710 can direct the revenue share component 410 to automatically provide the licensor with 100 percent of the revenue generated as a result of the improper use.

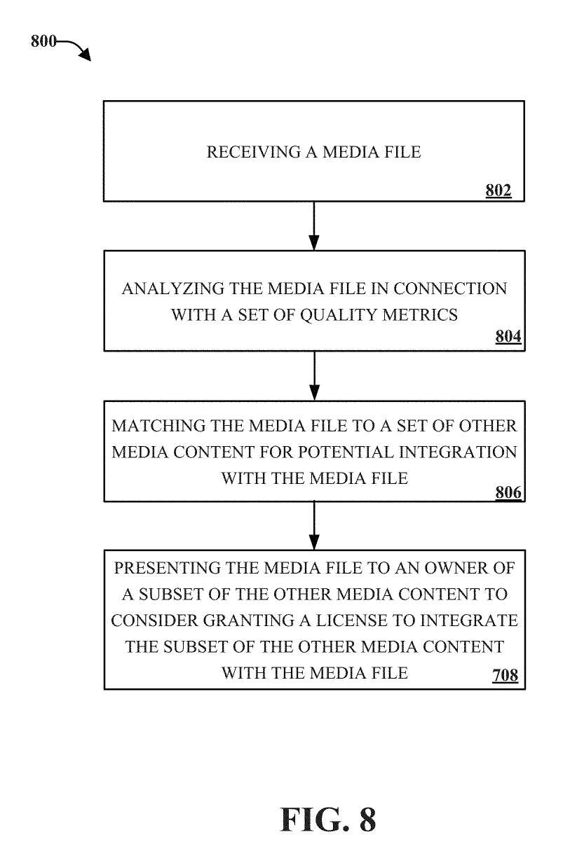

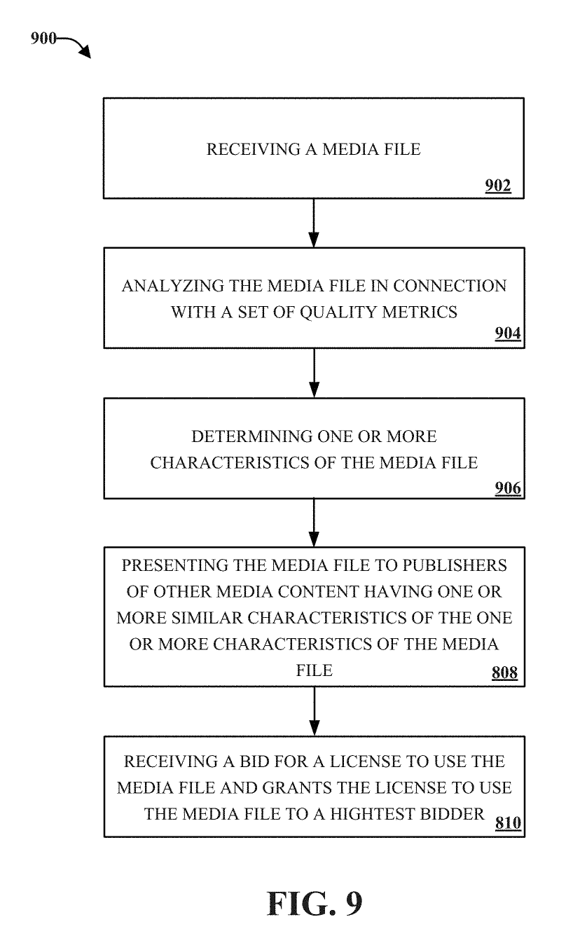

FIGS. 8 and 9 illustrate methodologies or flow diagrams in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

Referring now to FIG. 8, presented is a flow diagram of an example application of systems disclosed in this description accordance with an embodiment. In an aspect, exemplary methodology 800, a media collaboration system is stored in a memory and utilizes a processor to execute computer executable instructions to perform functions. At 802 a media file is received, (e.g. using reception component 110). For example, a homegrown media file can be received comprising a puppies playing in a field. At 804, the media file can be analyzed in connection with a set of quality metrics (e.g. using analysis component 120). For example, the analysis component 120 can determine general quality of the puppy video and/or characteristics such as encoding, resolution, format and fidelity. At 806, the media file is matched to a set of other media content for potential integration with the media file (e.g. using matching component 140). For example, the puppy video may be matched to various mainstream audio tracks for potential dubbing to the puppy video. Then at 708, the media file is presented to an owner of a subset of the other media content to consider granting a license to integrate the subset of the other media content with the media file (e.g. using licensing component). For example, the media file can be presented to “Mainstream Records” for consideration of granting a license to the owner of the puppy media file to integrate the audio track “Running in the Fields” with the puppy video.

Referring now to FIG. 9, presented is a flow diagram of an example application of systems disclosed in this description accordance with an embodiment. In an aspect, exemplary methodology 900, a media collaboration system is stored in a memory and utilizes a processor to execute computer executable instructions to perform functions. At 902 a media file is received, (e.g. using reception component 110). At 904, the media file is analyzed in connection with a set of quality metrics (e.g. using analysis component 120). At 906, one or more characteristics of the media file is determined (e.g. using analysis component 120 and/or inference component 130). At 908, the media file is presented to publishers of other media content having one or more similar characteristics of the one or more characteristics of the media file (e.g. using auctioning component 610). At 910, a bid is received for a license to use the media file and the license is granted to the highest bidder (e.g. using licensing component 150).

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described in this disclosure. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

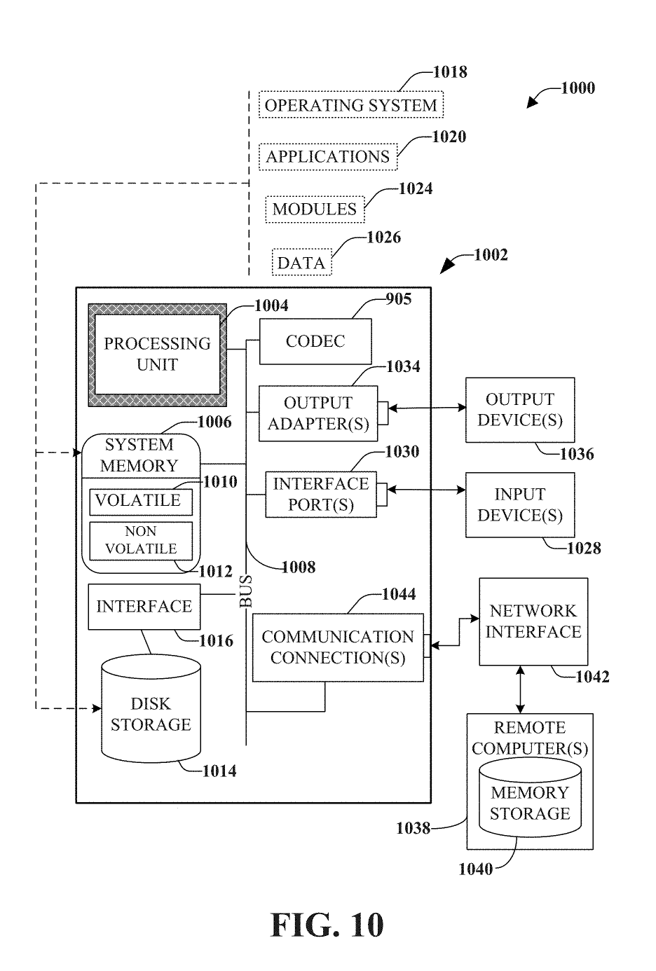

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. In an aspect, processing unit 1004 and system memory 1006 can represent processor 160 and memory 170 respectively. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1005 may include at least one of an encoder or decoder, wherein the at least one of an encoder or decoder may consist of hardware, a combination of hardware and software, or software. Although, codec 1005 is depicted as a separate component, codec 1005 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 718 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

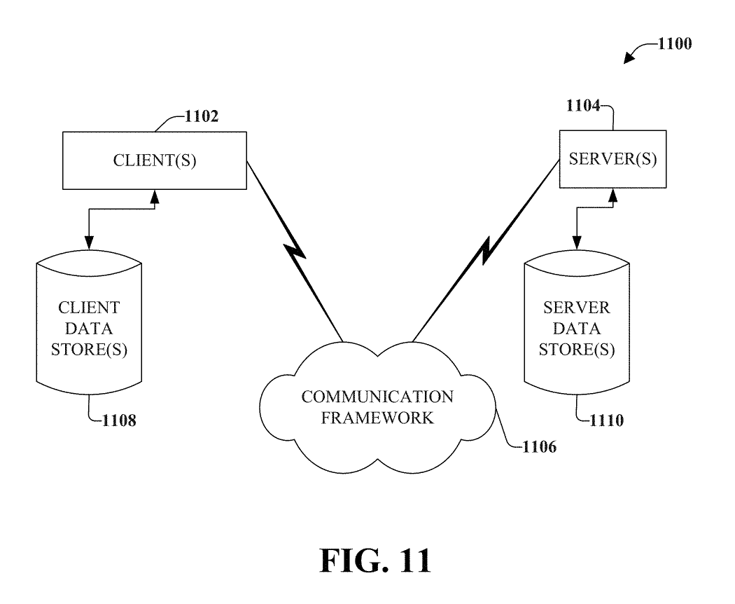

Referring now to FIG. 11, there is illustrated a schematic block diagram of a computing environment 1100 in accordance with this disclosure. The system 1100 includes one or more client(s) 1102 (e.g., laptops, smart phones, PDAs, media players, computers, portable electronic devices, tablets, and the like). System 1100 can for example be employed in connection with implementing one or more of the systems or component described herein show in FIGS. 1-7. The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include metadata, e.g., associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 include or are operatively connected to one or more client data store(s) 1108 that can be employed to store information local to the client(s) 1102 (e.g., associated contextual information). Similarly, the server(s) 1104 are operatively include or are operatively connected to one or more server data store(s) 1111 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

1. A system comprising:
a memory;
one or more microprocessors of a server operatively coupled to the memory to:
analyze, by the server, a media file to identify characteristics of the media file;
match, by the server, the media file to media content based on the characteristics of the media file, wherein the media file comprises video content and the media content comprises audio content;
provide for presentation, by the server, the media file to an owner of the media content with a request for a license for the media content;
receive, by the server, the license for the media content;
responsive to receiving the license for the media content, integrate the media content comprising the audio content into the video content of the media file; and
provide for presentation, by the server, the video content and the audio content of the media file, wherein a portion of the video content and the audio content are played concurrently.

2. The system of claim 1, wherein the match is based in part on potential monetization of a new media file generated by integrating the media file with the media content.

3. The system of claim 2, further comprising the one or more microprocessors to:
authorize a grant of the license to integrate the media content with the media file in response to the potential monetization of the new media file being above a pre-determined threshold.

4. The system of claim 1, wherein the match is based in part on a similarity between the media file and the media content.

5. The system of claim 1, further comprising the one or more microprocessors to infer a description of the media file based on content of the media file, and wherein the matching is based in part on the description.

6. The system of claim 1, further comprising the one or more microprocessors to:
receive user preferences regarding the media content, and wherein the matching is based in part on the user preferences.

7. The system of claim 1, further comprising the one or more microprocessors to:
share revenue with owners of content associated with a new media file generated by integrating the media file with the media content.

8. The system of claim 7, further comprising the one or more microprocessors to:
present the new media file to potential advertisers in connection with purchasing advertisement space associated with the new media file.

9. The system of claim 8, wherein to match comprises the microprocessors to analyze historical information and identify a match between a video, a licensed content, and an advertiser.

10. The system of claim 8, wherein to match comprises the microprocessors to analyze market trending data and identify a match between a video, a licensed content, and an advertiser.

11. A method comprising:
analyze, by one or more microprocessors, a media file to identify characteristics of the media file;
matching, by the one or more microprocessors, the media file to a media content based on the characteristics of the media file, wherein the media file comprises video content and the media content comprises audio content;
presenting the media file to an owner of the media content with a request for a license for the media content;
receiving, by the server, the license for the media content;
responsive to receiving the license for the media content, integrating the media content comprising the audio content into the video content of the media file and
provide for presentation the video content and the audio content of the media file, wherein a portion of the video content and the audio content are played concurrently.

12. The method of claim 11, wherein the matching comprises matching the media file to a set of other media content based in part on potential monetization of a new media file generated by integrating the media file with the a subset of the other media content.

13. The method of claim 12, further comprising:
authorizing a grant of the license to integrate the subset of the other media content with the media file in response to the potential monetization of the new media file is above a pre-determined threshold.

14. The method of claim 11, wherein the matching comprises matching the media file to a set of other media content based in part on a similarity between the media file and the other media content.

15. The method of claim 11, further comprising:
inferring a description of the media file based on content of the media file, wherein the matching comprises matching the media file to a set of other media content based in part on the description.

16. The method of claim 11, further comprising:
receiving user preferences regarding a set of other media content, and wherein the matching comprises matching the media file to the set of other media content based at least in part on the user preferences.

17. The method of claim 11, further comprising:
generating a new media file by integrating the media file with the media content; and
sharing revenue with owners of content associated with the new media file.

18. The method of claim 17, further comprising:
presenting the new media file to potential advertisers in connection with purchasing advertisement space associated with the new media file.

19. The method of claim 18, wherein the matching comprises matching the media file to a set of other media content based in part on historical information to identify strong matches between video, licensed content, and advertisers.

20. The method of claim 18, wherein the matching comprises matching the media file to a set of other media content based in part on market trending data to identify strong matches between video, licensed content, and advertisers.

21. A system comprising:
at least one non-transitory computer readable medium having stored therein computer-executable components;
at least one microprocessor that executes the following computer executable components stored on the at least one non-transitory computer readable medium:
a reception component that receives a media file;
an analysis component that analyzes the media file in connection with a set of quality metrics and determines one or more characteristics of the media file;
an auctioning component that presents the media file to publishers of other media content having one or more similar characteristics of the one or more characteristics of the media file; and
a licensing component that receives a bid for a license to use the media file and grants the license to use the media file to a highest bidder.

22. The system of claim 21, further comprising:
a revenue share component that shares revenue associated with usage of the media file by the highest bidder with owners of the media file and the highest bidder in response to granting the license.
